(19) United States
(12) Patent Application Publication
(10) Pub. No.: US 2026/0349132 A1
(43) Pub. Date: Nov. 5, 2026

(54) METHOD AND SYSTEM FOR ROCKBURST EARLY WARNING BASED ON MULTI-SCALE MICROSTRUCTURE PARAMETER FUSION OF COAL-ROCK MASS, AND STORAGE MEDIUM

(71) Applicant: CCTEG CHINESE INSTITUTE OF COAL SCIENCE, BEIJING (CN)

(72) Inventors: XIAOSHAN SHI, BEIJING (CN); HAITAO LI, BEIJING (CN); WEISHENG DU, BEIJING (CN); QINGXIN QI, BEIJING (CN); MINGWEI JIANG, BEIJING (CN); XIANTAO LI, BEIJING (CN); XUEWEI XU, BEIJING (CN)

(21) Appl. No.: 19/660,173

(22) Filed: Apr. 27, 2026

(30) Foreign Application Priority Data
Apr. 30, 2025 (CN) 2025105709811

(51) Int. Cl. G01V 1/34; E21C 39/00; E21F 17/18; G01V 1/28; G01V 1/30

(52) U.S. Cl. CPC G01V 1/345; E21C 39/00; E21F 17/18; G01V 1/282; G01V 1/301; G01V 2210/646

(57) ABSTRACT

A method for rockburst early warning based on multi-scale microstructure parameter fusion of a coal-rock mass includes: collecting monitoring data of a coal-rock mass microstructure via a monitoring system, and obtaining a multi-scale microstructure parameter by processing the monitoring data; determining a quantitative relationship between the multi-scale microstructure parameter and a risk of rockburst occurrence and a core association mechanism; constructing and training a fusion model, based on the quantitative relationship and the core association mechanism; and collecting real-time monitoring data of a coal-rock mass to be predicted via the monitoring system, and obtaining a dynamic rockburst early warning result by inputting the real-time monitoring data into the fusion model trained.

### CROSS-REFERENCE TO RELATED PATENT APPLICATION

This application claims priority to Chinese Patent Application No. 2025105709811 filed on Apr. 30, 2025, the entire content of which is incorporated herein by reference by all purposes.

### FIELD OF THE DISCLOSURE

The present disclosure relates to a technical field of coal mine safety engineering, and more particularly to a method and a system for rockburst early warning based on multi-scale microstructure parameter fusion of a coal-rock mass, and a storage medium.

### BACKGROUND OF THE DISCLOSURE

In coal mining operations, a rockburst poses a serious threat to a safety production. An occurrence of the rockburst is closely related to internal microstructure changes of a coal-rock mass. From mineral crystal structures, micro-pores and micro-cracks at a micro-level to bedding, joints and other structures at a macro-level, any change in these parameters may cause a change in a stress distribution, thereby inducing the rockburst. Therefore, it is necessary to monitor microstructure parameters of the coal-rock mass to perform a rockburst early warning according to monitoring data.

### SUMMARY OF THE DISCLOSURE

In a first aspect of the present disclosure, a method for rockburst early warning based on multi-scale microstructure parameter fusion of a coal-rock mass is provided, which includes:
collecting monitoring data of a coal-rock mass microstructure via a monitoring system including micro-scale monitoring, meso-scale monitoring, and macro-scale monitoring, and obtaining a multi-scale microstructure parameter by processing the monitoring data, in which the multi-scale microstructure parameter includes a micro-scale structural sensitivity parameter, a meso-scale mechanical response parameter, and a macro-scale energy release parameter;
establishing a quantitative relationship between the multi-scale microstructure parameter and a risk of rockburst occurrence, and determining a core association mechanism between the multi-scale microstructure parameter and the risk of rockburst occurrence;
constructing and training a fusion model based on the quantitative relationship and the core association mechanism, in which the fusion model is configured to output a rockburst risk probability based on an input multi-scale fusion parameter; and
collecting real-time monitoring data of a coal-rock mass to be predicted via the monitoring system, and obtaining a dynamic rockburst early warning result by inputting the real-time monitoring data into the fusion model trained.

In a second aspect of the present disclosure, a system for rockburst early warning based on multi-scale microstructure parameter fusion of a coal-rock mass is provided, which includes: a monitoring system including micro-scale monitoring, meso-scale monitoring, and macro-scale monitoring, and a computer device comprising a memory and a processor.

The monitoring system is configured to collect monitoring data of a coal-rock mass microstructure, and collect real-time monitoring data of a coal-rock mass to be predicted. When instructions in the memory are executed, the processor is configured to obtain a multi-scale microstructure parameter by processing the monitoring data, in which the multi-scale microstructure parameter includes a micro-scale structural sensitivity parameter, a meso-scale mechanical response parameter, and a macro-scale energy release parameter;
establish a quantitative relationship between the multi-scale microstructure parameter and a risk of rockburst occurrence, and determine a core association mechanism between the multi-scale microstructure parameter and the risk of rockburst occurrence;
construct and train a fusion model based on the quantitative relationship and the core association mechanism, in which the fusion model is configured to output a rockburst risk probability based on an input multi-scale fusion parameter; and
collect real-time monitoring data of a coal-rock mass to be predicted via the monitoring system, and obtain a dynamic rockburst early warning result by inputting the real-time monitoring data into the fusion model trained.

In a third aspect of the present disclosure, a non-transitory computer-readable storage medium is provided, which stores a computer program that, when executed by a processor, implements the method for rockburst early warning based on multi-scale microstructure parameter fusion of coal-rock mass in the first aspect.

Additional aspects and advantages of the present disclosure will be given in part in the following descriptions, become apparent in part from the following descriptions, or be learned from the practice of the present disclosure.

### BRIEF DESCRIPTION OF THE DRAWINGS

The above and/or additional aspects and advantages of the present disclosure will become apparent and more readily appreciated from the following descriptions of embodiments made with reference to the drawings, in which:

FIG. 1 is a flowchart of a method for rockburst early warning based on multi-scale microstructure parameter fusion of a coal-rock mass provided by an embodiment of the present disclosure;

FIG. 2 is a flowchart of a method for generating a quantitative relationship provided by an embodiment of the present disclosure; and

FIG. 3 is a block diagram of a system for rockburst early warning based on multi-scale microstructure parameter fusion of a coal-rock mass provided by an embodiment of the present disclosure.

### DETAILED DESCRIPTION OF THE EXEMPLARY EMBODIMENTS

Embodiments of the present disclosure will be described in detail below, and examples of embodiments are illustrated in the drawings. The same or similar elements or the elements having the same or similar functions are denoted by like reference numerals throughout the descriptions. Embodiments described herein with reference to drawings are illustrative, serve to explain the present disclosure, and cannot be construed to limit the present disclosure.

It should be noted that a single method for monitoring multi-scale microstructure parameter of a coal-rock mass in related embodiments cannot comprehensively obtain multi-scale microstructure information of the coal-rock mass. For example, conventional stress monitoring may only reflect a macroscopic stress state and is difficult to delve into a microstructure level; although analytical methods such as scanning electron microscopy or CT scanning at a micro-level are capable of observing an internal microstructure of the coal-rock mass, they are difficult to establish an effective association with a macro-scale mining environment and cannot achieve real-time and dynamic monitoring. On the other hand, data processing and analyzing methods in the related embodiments are relatively simple and crude, making it impossible to accurately extract change features of microstructure parameters directly related to the rockburst from massive monitoring data, resulting in a lack of accurate basis for the prediction and prevention of the rockburst, and making it difficult to meet actual requirements of safe and efficient coal mining.

In other words, a single monitoring technology for a microstructure parameter is generally adopted in the related art, which cannot obtain comprehensive microstructure information of the coal-rock mass, and a process of processing and analyzing collected data is also relatively simple, making it impossible to accurately obtain information required for the rockburst early warning, which may lead to a large deviation in results of the rockburst early warning, and cannot meet actual warning requirements.

To this end, the present disclosure provides a method for rockburst early warning based on multi-scale microstructure parameter fusion of a coal-rock mass. The method may accurately obtain change information of a multi-scale microstructure parameter of the coal-rock mass from micro-scale to macro-scale, and provide real-time and accurate rockburst early warning information via a multi-source network model, which improves the accuracy and real-time performance of rockburst early warning.

A method and system for rockburst early warning based on multi-scale microstructure parameter fusion of a coal-rock mass provided by embodiments of the present disclosure are described below with reference to drawings.

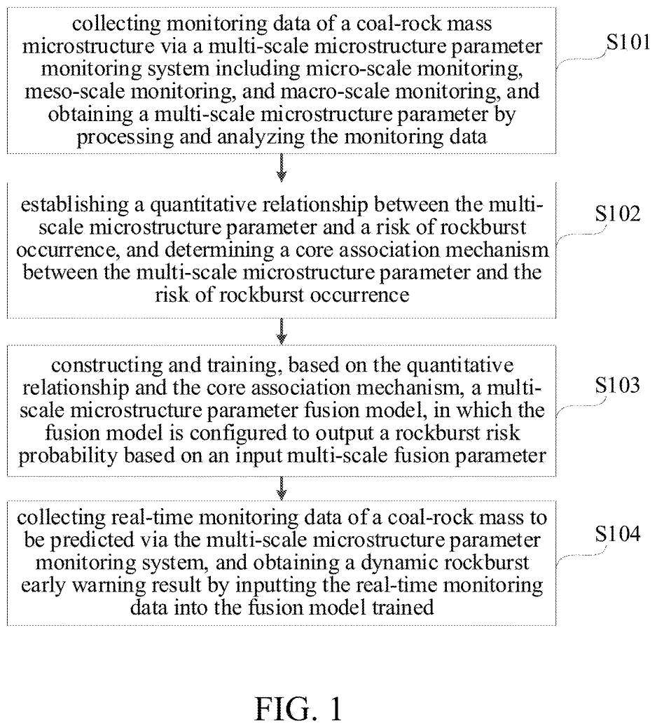

FIG. 1 is a flowchart of a method for rockburst early warning based on multi-scale microstructure parameter fusion of a coal-rock mass provided by an embodiment of the present disclosure. As shown in FIG. 1, the method includes the following steps at S101-S104.

At S101, monitoring data of a coal-rock mass microstructure is collected via a multi-scale microstructure parameter monitoring system including micro-scale monitoring, meso-scale monitoring and macro-scale monitoring, and a multi-scale microstructure parameter is obtained by processing and analyzing the monitoring data.

The multi-scale microstructure parameter includes a plurality of micro-scale structural sensitivity parameters, a plurality of meso-scale mechanical response parameters, and a plurality of macro-scale energy release parameters.

Specifically, the present disclosure first constructs the multi-scale microstructure parameter monitoring system including the micro-scale monitoring, the meso-scale monitoring and the macro-scale monitoring, then constructs a data collection and transmission system for data transmission, and then develops a multi-scale microstructure parameter analysis algorithm to perform respective processing and analyzing on various monitoring data collected by the multi-scale microstructure parameter monitoring system, thereby correspondingly obtaining the micro-scale structural sensitivity parameters, the meso-scale mechanical response parameters, and the macro-scale energy release parameters.

In one embodiment of the present disclosure, for the micro-scale monitoring in the constructed multi-scale monitoring system, on the one hand, a high-resolution microscopic imaging technology, such as a combination technology of a field emission scanning electron microscopy (FESEM) and a focused ion beam scanning electron microscopy (FIB-SEM) is adopted to perform a micro-scale observation of a coal-rock mass sample (with a resolution being less than or equal to 10 nm), and the directly collected data includes: a spatial distribution image of micro-pores (such as, a pore size, a shape, and three-dimensional coordinates), an initiation position and propagation trajectory of micro-cracks (such as, a crack starting point, branching point coordinates, and a propagation direction), and a morphological parameter of mineral crystals (such as, a crystal type, a particle size, an arrangement orientation). On the other hand, a multi-field coupled in-situ CT technology is adopted to collect an image sequence (with a resolution of 1-10 μm) of dynamic evolution of the micro-cracks inside the coal-rock mass under different environmental fields (such as, stress, seepage, a high temperature and a low temperature), and original stress-strain curve data under a corresponding loading condition. On yet another hand, an atomic force microscope (AFM) is used to measure a microscopic regional surface morphology image (with the accuracy up to nm) and a point-by-point mechanical parameter (such as, an original test value matrix of elastic modulus and hardness).

For the meso-scale monitoring in the multi-scale monitoring system constructed by the present disclosure, on the one hand, an ultrasonic CT technology is used to arrange N ultrasonic transmitting probes and M receiving probes in a coal mining area to construct a three-dimensional monitoring network with a network spacing of 5 to 10 m. Thus, features such as a propagation velocity and an attenuation of ultrasonic in the coal-rock mass may be directly obtained. Black and white random speckles (with a particle size of 50 to 100 μm) may also be sprayed on a surface of the coal-rock mass as deformation tracking markers. On the other hand, a digital image correlation (DIC) technology is adopted to collect images of the coal-rock mass before and after deformation via a high-speed camera (with a frame rate≥100 fps) to monitor surface deformation of the coal-rock mass.

For the macro-scale monitoring in the multi-scale monitoring system constructed by the present disclosure, on the one hand, a micro-seismic monitoring system is used to arrange greater than or equal to 6 micro-seismic sensors (with a sensitivity being greater than or equal to 100 Hz) in an entire coal mining area, and a time-difference positioning method (S-P wave arrival time difference, i.e., an arrival time difference between P-waves (primary waves or pressure waves) and S-waves (secondary waves or shear waves)) is adopted to calculate three-dimensional coordinates of micro-seismic events with a positioning error being less than or equal to 5 m. On the other hand, an acoustic emission monitoring technology is combined to capture an acoustic emission signal generated inside the coal-rock mass due to a micro-crack propagation, a friction, etc., further supplementing macro-scale structural change information.

Further, in this embodiment, a data collection and transmission system is also constructed to collect data monitored by the above multi-scale monitoring system and transmit it to a backend center for data analysis and processing. In a specific implementation, a professional data collection device is equipped to achieve a high-speed and high-precision collection of various monitoring signals. For example, imaging data and mechanical test data from a micro-scale monitoring technology are collected by a professional data collection card; ultrasonic CT, micro-seismic and acoustic emission monitoring data are collected by a dedicated data collector. Also, a high-speed and stable wireless transmission network is constructed to transmit the collected data to a ground data processing center in real time. A 5G communication technology is combined with an underground dedicated wireless relay equipment to ensure the reliability and low latency of the data transmission, meeting requirements of real-time monitoring and analyzing.

Furthermore, the multi-scale microstructure parameter is obtained by processing and analyzing collected original monitoring data. Specifically, the above original monitoring data may be processed via an image recognition algorithm and a machine learning algorithm to analyze and obtain the plurality of micro-pore parameters (such as, a porosity, a pore fractal dimension, an average pore diameter, and a pore size distribution probability density), the plurality of micro-crack parameters (such as, a crack density, a fracture porosity, a fracture fractal dimension, and a fracture connectivity), and the plurality of mineral structure parameters (such as, a mineral interface debonding rate and a crystal orientation consistency index). The data obtained from preliminary analysis may also be used to analyze a mechanical association parameter and a dynamic evolution feature.

The exemplary explanation of the specific process of obtaining microstructure parameters at each scale by processing and analyzing the monitoring data in the present disclosure is described below.

In one embodiment of the present disclosure, the obtained micro-scale structural sensitivity parameter includes: a plurality of micro-pore parameters, a plurality of micro-crack parameters, and a plurality of mineral structure parameters, and obtaining the multi-scale microstructure parameter by processing and analyzing the monitoring data includes: performing binarization processing on microscopic image data collected by using a microscopic imaging technology, and calculating the plurality of micro-pore parameters based on a binarization processing result; extracting a crack centerline from the microscopic image data, identifying a crack initiation position and a crack propagation trajectory from an in-situ CT image sequence, and calculating the plurality of micro-crack parameters based on obtained crack information; and calculating the plurality of mineral structure parameters by identifying a mineral phase and analyzing a grain boundary change based on the in-situ CT image sequence.

Specifically, in this embodiment, a micro-pore parameter analysis is first performed. Preprocessing the image data collected by the above monitoring system includes: using a threshold segmentation algorithm (such as, Otsu method) to binarize the FESEM/CT image, separating a pore (a black area) from a solid matrix (a white area). Then, based on a three-dimensional tomographic image, a three-dimensional spatial model of the pores is reconstructed using the Marching Cubes algorithm. Based on this processing, the following parameters (1)-(3) may be obtained via analysis and calculation.
(1) the porosity n is obtained by calculating a percentage of a pore volume (i.e., a sum of voxels in the black area in the binarized image) to a total sample volume, and may be calculated by the following formula of:

η=Vₚₒᵣₑ/Vₛₐₘₚₗₑ×100%.
(2) the pore fractal dimension Dₚₒᵣₑ is an absolute value of a slope of a curve (a relationship between a number of grids and a scale on a logarithmic coordinate system is fitted by covering a pore boundary with the grids of different scales in a box-counting method), and reflects the complexity of the pore shape.
(3) the average pore diameter and pore size distribution are obtained by: labeling a pore in the binarized image, measuring an equivalent diameter (an equivalent circle diameter) of each pore, counting the pore size distribution probability density f(d), and calculating an arithmetic mean by the following formula of:

$$\overline{d} = \frac{{\sum }_{i = 1}^{n} {d}_{i}}{n} .$$

In this embodiment, the micro-pore parameter analysis is also performed. Crack identification and tracking processing are performed on the data collected by the above monitoring system, including: performing an edge detection (e.g., using a Canny operator) on the FESEM/FIB-SEM image, extracting the crack centerline by a skeletonization algorithm; identifying the crack initiation positions (Δ gray value being greater than or equal to a threshold) by processing the in-situ CT image sequence with a dynamic difference method, tracking the crack propagation trajectory with an optical flow method, and recording coordinates of a starting point and a branching point, and a propagation direction. Based on this processing, the following parameters (1)-(4) may be obtained via analysis and calculation.
(1) the crack density ρc is obtained by first counting a number of independent cracks per unit area (mm²) and then performing calculation based on the following formula of:

ρc=N_{crack}/A_{observation area}(cracks/mm²).
(2) the fracture porosity is obtained by calculating a percentage of a total crack area to an observation area, and its calculation method is similar to that for the porosity, i.e., the pore in the above formula of calculating the porosity may be replaced with a crack.
(3) the fracture fractal dimension Df is obtained by analyzing the complexity of crack spatial distribution based on a crack network skeleton with the box-counting method or a box-counting dimension method.
(4) the fracture connectivity. During a calculation of this parameter, a proportion of a number of interconnected cracks to a total number of cracks is counted, and a connectivity of crack nodes is judged by a graph theory algorithm (such as, an adjacency matrix).

In this embodiment, a mineral structure parameter analysis is also performed. The steps of identifying the mineral phase and analyzing the interface for the data collected by the above monitoring system include: analyzing a mineral composition by using an energy dispersive spectrometer (EDS) attached to the FESEM, and delineating boundaries between different mineral phases; then extracting a grain boundary between grains by an image segmentation technology, and comparing a grain boundary change before and after loading the above in-situ CT sequence data to identify a debonded interface (such as, interface spacing Δ≥2 nm is considered debonding). Based on this processing, the following parameters (1)-(2) may be obtained via analysis and calculation.
(1) the mineral interface debonding rate δ may be calculated by the following formula of:

δ=L_{debonded grain boundary}/L_{total grain boundary}×100%.
(2) the crystal orientation consistency index. During a calculation of this parameter, based on electron backscatter diffraction (EBSD) data, a standard deviation of an angle between a c-axis direction and a loading direction of a crystal is calculated. The smaller the standard deviation, the higher the orientation consistency.

In one embodiment of the present disclosure, the meso-scale mechanical response parameter includes: an ultrasonic attenuation coefficient and a meso-scale strain localization degree, and obtaining the multi-scale microstructure parameter by processing and analyzing the monitoring data further includes: calculating the ultrasonic attenuation coefficient by processing a collected ultrasonic CT signal; and calculating the meso-scale strain localization degree by analyzing a coal-rock mass deformation image, in which the coal-rock mass deformation image is collected by using a DIC technology.

Specifically, in this embodiment, first processing the ultrasonic CT signals collected by the above monitoring system includes performing band-pass filtering (a filter range may be selected as 50 to 500 kHz) on a received signal, and extracting a first arrival time of a wave by using a cross-correlation method; then obtaining a P wave velocity Vp and a S wave velocity Vs by inverting an internal wave velocity distribution of the coal-rock mass based on a simultaneous iterative reconstruction technology (SIRT) or an algebraic reconstruction technology (ART). Based on this processing, the ultrasonic attenuation coefficient may be calculated.

The ultrasonic attenuation coefficient is defined as an amplitude attenuation rate of a signal per unit distance and may be calculated by the following formula of:

$$α = \frac{20 {log}_{10} ( {A}_{0} / {A}_{d} )}{d} ,$$

where a unit of this parameter is dB/m, A₀ is a transmission amplitude, and A_{d} is a received amplitude at the distance d. Based on the above processing, an attenuation rate of an ultrasonic longitudinal wave velocity (Δv/v0, unit: %) may also be calculated.

In this embodiment, the meso-scale strain localization degree ε₁ is also calculated by analyzing the parameter collected by the above DIC technology. First, a displacement vector is calculated, and a displacement vector (u, v) at each point is calculated by a sub-pixel level cross-correlation algorithm (such as, using a window size of 32×32 pixels, with an overlap rate of 50%). Then, a strain is calculated, and various engineering strains are calculated by a gradient matrix fitted by a least squares method according to the calculated displacement field. Finally, the meso-scale strain localization degree ε₁ is calculated, which is defined as an area proportion of a local strain concentration region (strain≥2 times the mean value) in this calculation process, reflecting the non-uniformity of deformation.

In one embodiment of the present disclosure, the obtained macro-scale energy release parameter includes: a cumulative value of micro-seismic energy and a high-frequency component proportion of an acoustic emission signal, and obtaining the multi-scale microstructure parameter by processing and analyzing the monitoring data further includes: calculating the cumulative value of micro-seismic energy by analyzing a micro-seismic event parameter collected by a micro-seismic monitoring system; and calculating the high-frequency component proportion of the acoustic emission signal by analyzing an acoustic emission signal inside the coal-rock mass, in which the acoustic emission signal inside the coal-rock mass is collected by using an acoustic emission monitoring technology.

Specifically, in this embodiment, a micro-seismic monitoring parameter is first analyzed. First, the micro-seismic energy is calculated, and may be calculated based on a relationship between a magnitude and an energy expressed by the following formula of:

E=10^{1.5M+4.8}
where M is the magnitude.

Alternatively, a velocity signal kinetic energy may also be directly integrated, i.e., calculated by a following formula:

$$E = \frac{1}{2} ρ V \int {v}^{2} ( t ) dt$$

where ρ is a medium density, and V is a seismic source volume.

Then, a cumulative value of the micro-seismic energy Eacc is calculated, and an energy may be accumulated over a time window (such as, 1 hour).

A spatial distribution concentration may also be calculated by a standard deviation of a coordinate of the micro-seismic event, reflecting a spatial aggregation degree of energy release.

In this embodiment, an acoustic emission monitoring parameter is also analyzed. First, preprocessing the collected acoustic emission signal includes performing wavelet denoising on an original acoustic emission signal (a sensor bandwidth corresponding to this signal is 10 to 200 kHz) and decomposing it into different frequency layers (such as, 5-layer decomposition is performed for db4 wavelet).

Then, a spectrum analysis is performed. A power spectral density is calculated by using the Fast Fourier Transform (FFT), and a main frequency fmain is extracted. Compared with the main frequency in an initial state ƒ₀, an offset may thus be obtained by the following formula of:

Δƒ=|ƒₘₐᵢₙ−ƒ₀|

Then, the high-frequency component proportion fH is calculated, i.e., a percentage of an energy in a frequency band above 100 kHz to a total energy may be calculated by the following formula of:

$$fH = \frac{{E}_{> 100 kHz}}{{E}_{total}} \times 100 \%$$

In one embodiment of the present disclosure, the mechanical association analysis may also be performed based on an analysis process of the above parameters at each scale. Specifically, in this embodiment, a quantitative relationship between a micro-porosity and the fracture fractal dimension, and an elastic modulus (E) and the hardness (H) is first established based on the above data collected by AFM and the stress-strain curve involved in the in-situ CT data analysis. This quantitative relationship may be expressed by the following formula of:

E=ƒ(η,D_{ƒ})

Thus, a coupling effect between a mineral interface bonding strength and a micro-crack evolution may be characterized.

In this embodiment, the dynamic evolution feature is also analyzed, which includes determining a micro-crack propagation rate (μm/s) and a pore expansion rate (%/loading step) under a multi-field coupling condition, and an influence coefficient of different environmental fields (such as, a stress gradient and a temperature change) on the microstructure parameter (such as, determining an increase in porosity Δη for every 10 °C increase in temperature).

It should be noted that the monitoring technologies at various levels and the corresponding data processing and analyzing methods, adopted by the above multi-scale monitoring system may be adjusted according to monitoring needs, which is not limited in the present disclosure. In actual applications, the monitoring system may be arranged and related processes of data monitoring, collection, transmission, processing and analysis may be performed, according to an actual situation of the mining area.

As an example, in a first step, a representative monitoring position is selected in the coal mining area, and micro-scale monitoring equipment, meso-scale monitoring equipment and macro-scale monitoring equipment are reasonably arranged according to monitoring requirements of different scales. For example, a micro-sample collection point is set near a mining working face, an ultrasonic CT probe is arranged at certain intervals, and micro-seismic sensors and acoustic emission sensors are evenly distributed throughout the mining area. In a second step, monitoring equipment is installed and debugged to ensure a normal operation of the equipment. The equipment is regularly calibrated and maintained to ensure the accuracy and reliability of the monitoring data. For example, a resolution of micro-scale imaging equipment is regularly calibrated, a probe performance of ultrasonic CT equipment is checked, and the sensitivity of both the micro-seismic sensors and the acoustic emission sensors is tested. In a third step, a data collection device is started according to a set sampling frequency and collection mode to collect data generated by each monitoring module in real time. For example, microscopic imaging data is collected once per hour, ultrasonic CT data is collected every 10 minutes, and micro-seismic data and acoustic emission data are collected continuously in real time. In a fourth step, the collected data is transmitted to the ground data processing center in real time via the wireless transmission network. During the transmission process, the security and integrity of the data are ensured by using a data encryption and verification technology. In a fifth step, the transmitted data is processed at the ground data processing center. The original data is first preprocessed, including denoising, filtering, data format conversion, etc. For example, the micro-seismic data and the acoustic emission data are denoised by using a wavelet denoising algorithm. In a sixth step, the multi-scale microstructure parameter is extracted by using respective data processing and analyzing algorithms.

At S102, a quantitative relationship between the multi-scale microstructure parameter and a risk of rockburst occurrence is established, and a core association mechanism between the multi-scale microstructure parameter and the risk of rockburst occurrence is determined.

Specifically, according to the manner described in the previous step, a large number of multi-scale microstructure parameters may be obtained. By analyzing massive multi-scale microstructure parameters under different rockburst events, the quantitative relationship between the multi-scale microstructure parameter and the risk of rockburst occurrence may be established.

For example, a multiple linear regression model or a neural network model may be constructed and trained via historical data, and the trained model generates a quantitative relationship between parameters at different scales, and an overall mechanical property of the coal-rock mass and the risk of rockburst occurrence. A model parameter input set is the above parameters at three types of scales, in which the micro-scale structural sensitivity parameter includes: the micro-porosity (η), the micro-crack density (ρc, cracks/mm²), the mineral interface debonding rate (δ, %), and the fracture fractal dimension (D_{f}, reflecting a crack complexity); the meso-scale mechanical response parameter includes: the attenuation rate of the ultrasonic longitudinal wave velocity (Δv/v0, %), and the meso-scale strain localization degree (ε₁, a local strain concentration coefficient measured by the DIC technology); and the macro-scale energy release parameter includes: the cumulative value of the micro-seismic energy (Eacc, J), the high-frequency component proportion of the acoustic emission signal (fH, an energy proportion of signal>100 kHz), and a stress gradient change rate (dσ/dx, MPa/m).

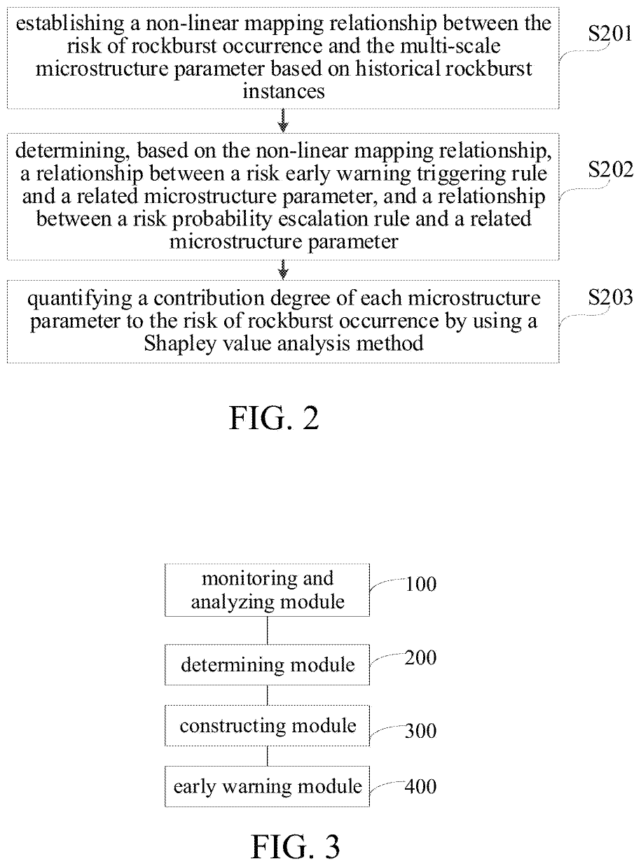

In order to more clearly illustrate the specific implementation process of generating the above quantitative relationship in the present disclosure, an illustrative description is given below using a method for generating a quantitative relationship provided in one embodiment of the present disclosure. FIG. 2 is a flowchart of a method for generating a quantitative relationship provided by an embodiment of the present disclosure. As shown in FIG. 2, the method includes the following steps at S201-S203.

At S201, a non-linear mapping relationship between the risk of rockburst occurrence and the multi-scale microstructure parameter is established based on historical rockburst instances.

Specifically, a large amount of historical data of multi-scale microstructure parameters may be obtained according to the manner described in the above embodiments, such as, the multi-scale microstructure parameter under historical rockburst instances (n=500+) and a correlation parameter of the rockburst event are obtained. The obtained data is used as training data to train the above multiple linear regression model or neural network model, thereby establishing the non-linear mapping relationship between the risk of rockburst occurrence and the multi-scale microstructure parameter, as shown in the following formula of:

R=ƒ(η,ρ_{c},δ,D_{ƒ},Δv/v0,ε₁,Eacc,ƒH,dσ/dx)

Then, this non-linear mapping relationship is used as a quantitative relationship expression for a risk of rockburst occurrence.

At S202, based on the non-linear mapping relationship, a relationship between a risk early warning triggering rule and a related microstructure parameter, and a relationship between a risk probability escalation rule and the related microstructure parameter are determined.

Specifically, in combination with the non-linear mapping relationship established above and a rule obtained by analyzing the obtained data of the historical rockburst instances, an influence of the related microstructure parameter on risk early warning triggering and risk probability escalation is determined.

For example, the determined risk early warning triggering rule is: triggering the risk early warning in a case where the micro-crack density ρc>5 cracks/mm² and a daily increase of the macro-scale micro-seismic energy Eacc>50%. The determined risk probability escalation rule is: escalating the risk probability by 30% to 50% in a case where the mineral interface debonding rate δ and the stress gradient change rate dσ/dx have a multiplicative effect, i.e., δ×dσ/dx>0.1 MPa.

At S203, a contribution degree of each microstructure parameter to the risk of rockburst occurrence is quantified by using a Shapley value analysis method.

Specifically, quantifying the contribution degree of each parameter by using the Shapley value analysis method includes verifying a basic influence of the microstructure parameter on the risk (with a contribution proportion of 40% to 60%) and a triggering effect of a macro-scale energy parameter on the risk (with a contribution proportion of 30% to 40%). The Shapley value analysis method is a game theory-based method. In this embodiment, a contribution degree of each microstructure parameter to a risk result of rockburst occurrence predicted by the model is quantified by using this algorithm. The importance of each feature is evaluated by calculating an average marginal contribution of each feature across all possible feature combinations, and an SHAP framework, etc. may be used in the quantification process.

Further, the present disclosure also determines a core association mechanism of the risk of rockburst occurrence. In one embodiment of the present disclosure, determining the core association mechanism between the multi-scale microstructure parameter and the risk of rockburst occurrence includes the following steps.

In a first step, based on a mechanical association analysis result, an association mechanism between micro-scale structural deterioration of the coal-rock mass and a stress concentration effect is determined. Based on the mechanical association analysis performed in embodiments of the step S101, the core association mechanism determined in this step is that: a micro-pore expansion (η↑) and a micro-crack coalescence (Df↑) lead to a decrease in a stiffness of the coal-rock mass (the elastic modulus E↓), forming a local stress concentration area (a stress concentration factor K≥3), which provides an energy accumulation condition for rockburst.

In a second step, by analyzing the meso-scale mechanical response parameters, an association mechanism between meso-scale damage evolution of the coal-rock mass and energy transfer abnormality is determined. The core association mechanism determined in this step is that: an ultrasonic attenuation rate Av/v0>15%, which indicates an initial formation of a meso-scale fracture network, and at this time, a strain localization degree ε₁ is greater than 0.8, leading to a sudden change in a stress transfer path and inducing a macro-scale stress imbalance.

In a third step, by analyzing the macro-scale energy release parameter, an association mechanism between macro-scale energy release and an instability critical point of the coal-rock mass is determined. The core association mechanism determined in this step is that: in a case where the micro-seismic energy Eacc exceeds 2 times the historical mean value for 3 consecutive days and the acoustic emission fH>40%, it indicates that the coal-rock mass enters an instability critical state, and at this time, the risk probability R≥0.7 and a pressure relief measure needs to be taken immediately.

At S103, based on the quantitative relationship and the core association mechanism, a multi-scale microstructure parameter fusion model is constructed and trained, in which the fusion model is configured to output a rockburst risk probability based on an input multi-scale fusion parameter.

Specifically, according to the quantitative relationship and the core association mechanism obtained in the previous step, a multi-source network model is constructed so that the multi-source network model may calculate the input multi-scale fusion parameter by using the quantitative relationship and the core association mechanism, to output the rockburst risk probability. The large number of historical rockburst instances obtained in the above embodiments may be used as the training data, and each set of training data includes a multi-scale microstructure parameter and its corresponding rockburst event data.

In one embodiment of the present disclosure, before constructing the multi-scale microstructure parameter fusion model, the method further includes: performing normalization processing on the multi-scale microstructure parameter; calculating, by using a mutual information (MI) method, a correlation degree between each normalized microstructure parameter and a rockburst event, and calculating a Spearman correlation coefficient corresponding to each microstructure parameter based on the correlation degree; and screening out a plurality of key parameters from the multi-scale microstructure parameter by using a recursive feature elimination (RFE) algorithm based on the Spearman correlation coefficient of each microstructure parameter, in which a Spearman correlation coefficient of each of the key parameters is greater than a preset screening threshold.

Specifically, in this embodiment, a fusion analysis on the multi-scale microstructure parameter is performed to achieve preprocessing and feature screening of model input data. First, normalization of the multi-scale microstructure parameter is performed. As a possible implementation, the above microscopic parameters (ρ, ρc, δ), meso-scale parameters (Δv/v0, ε1) and macro-scale parameters (Eacc, fH) are standardized by Z-score to eliminate an influence of dimensions, and in particular, the following formula may be used for standardization:

$${x}^{′} = \frac{x - μ}{σ}$$

Then, the feature screening is performed, and key parameters significantly correlated with rockburst are screened out by using the mutual information method and the RFE algorithm. First, a correlation between each microstructure parameter and the rockburst event is calculated by using the MI method, and the MI method is an information theory-based statistical method used to measure an interdependence between two random variables. Then, the Spearman correlation coefficient of each microstructure parameter to the rockburst event is calculated according to a calculation result of the MI method. A monotonic correlation between these two variables may be measured by the Spearman correlation coefficient, and the Spearman correlation coefficient is calculated by converting original data of the two variables into levels. Finally, according to the Spearman correlation coefficient of each parameter, the key parameters significantly correlated with the rockburst are screened out by the RFE algorithm, such as, a screening threshold is set that an absolute value of the Spearman correlation coefficient≥0.3, and the Spearman correlation coefficient of each parameter greater than this screening threshold is retained, thereby retaining 20 to 30 key parameters as the core features subsequently input to the multi-source network model.

Further, a three-layer fusion model is constructed. In one embodiment of the present disclosure, the constructed multi-scale microstructure parameter fusion model includes: a feature extraction layer, a cross-scale fusion layer, and a risk assessment layer. The feature extraction layer is a bottom layer, configured to extract, from an input multi-scale microstructure parameter, a data feature corresponding to the key parameter, for microscopic image data, a convolutional neural network (CNN) is configured to extract the data feature; and for time-series data, a long short-term memory (LSTM) network is configured to extract the data feature; the cross-scale fusion layer is a middle layer, configured to map different data features to a unified feature space and calculate a contribution weight of each of the data features to rockburst; and the risk assessment layer is a top layer, configured to output the rockburst risk probability.

Specifically, the model constructed in this embodiment includes the feature extraction layer at the bottom layer, the cross-scale fusion layer at the middle layer, and the risk assessment layer at the top layer. In the feature extraction layer at the bottom layer, for the microscopic image data, the CNN is configured to automatically extract a geometric feature such as a micro-crack fractal dimension and a pore morphology complexity; for time-series meso-scale and macro-scale data (such as, an ultrasonic CT inversion parameter, and a micro-seismic event sequence), a LSTM network is configured to capture a dynamic evolution rule of the parameter. In the cross-scale fusion layer at the middle layer, different modal features are mapped to the unified feature space via a fully connected layer, a contribution weight of each scale parameter to rockburst is calculated by introducing an attention mechanism, and a key influencing factor (such as, a coupling effect of micro-crack connectivity and macro-scale micro-seismic energy) is highlighted. In the risk assessment layer at the top layer, the rockburst risk probability (a continuous value ranging from 0 to 1) or risk level (levels I to IV) is output by using a Softmax classifier or a regression model, where the risk probability≥0.6 is defined as a high-risk early warning threshold.

Furthermore, the above model is trained, for a specific training process, reference may made to a training method in the related art, which is not limited in the present disclosure. After training, a model verification and dynamic correction may also be performed. As a possible implementation, a prediction accuracy of the model is evaluated by using a (5-fold) cross-validation. In a typical mining area test, an identification accuracy of the model for rockburst is ≥85%, and a false alarm rate of the model for rockburst is ≤10%. A training set is continuously updated via real-time monitoring data (automatic incremental learning weekly), and a parameter weight and risk threshold are dynamically corrected, thereby adapting to characteristic change of the coal-rock mass under different geological conditions.

At S104, real-time monitoring data of a coal-rock mass to be predicted is collected via the multi-scale microstructure parameter monitoring system, and a dynamic rockburst early warning result is obtained by inputting the real-time monitoring data into the fusion model trained.

Specifically, in an actual application at an underground mining site, for a current coal-rock mass for which rockburst early warning is to be performed, by using the multi-scale microstructure parameter monitoring system and data processing and analyzing method described in the step S101, original monitoring data of the current coal-rock mass may be collected, and a real-time monitoring result of the multi-scale microstructure parameter of the coal-rock mass is obtained by processing and analyzing the original monitoring data, and then the dynamic rockburst early warning result for the current coal-rock mass is obtained by inputting a real-time monitoring result into the fusion model trained.

Thus, the present disclosure, via the above multi-source network model and quantitative relationship, organically fuses the parameters obtained from micro-scale monitoring, meso-scale monitoring and macro-scale monitoring, which realizes a cross-scale mapping of the “microstructure parameter→a meso-scale damage feature→a macro-scale energy signal”, constructing a closed-loop logic of “a parameter anomaly→a risk classification→an early warning response”, and providing a quantitative basis for a rockburst prediction. The present disclosure inputs the extracted multi-scale microstructure parameter into the multi-scale microstructure parameter fusion model for parameter fusion and rockburst risk assessment. According to an assessment result, a rockburst early warning message may be sent to a coal mining department timely via related communication manners.

In summary, the method for rockburst early warning based on multi-scale microstructure parameter fusion of a coal-rock mass according to embodiments of the present disclosure first constructs a monitoring system that comprehensively covers the multi-scale microstructure of the coal-rock mass, and organically combines micro-scale, meso-scale and macro-scale monitoring technologies. The system may obtain structural change information of the coal-rock mass from different scales and different angles, which breaks a limitation of the traditional single monitoring method and provides a more comprehensive and deeper data support for rockburst prevention. Then, a multi-scale microstructure parameter fusion model is constructed. With the help of a series of dedicated processing and analyzing algorithms for different monitoring data, change features of microstructure parameter related to the rockburst are accurately extracted from massive monitoring data, which realizes an efficient conversion from the data to knowledge, and significantly improves the accuracy and reliability of rockburst prediction. Finally, real-time monitoring and dynamic analysis for the multi-scale microstructure parameter of the coal-rock mass may be achieved in actual application. By constructing a high-speed data collection and transmission system, structural changes of the coal-rock mass during a mining process may be captured in time, and the extracted key parameters are input into the multi-scale microstructure parameter fusion model for the parameter fusion and a rockburst risk assessment. Thus, a strong guarantee is provided for early warning and active prevention of the rockburst, and strict real-time requirements of coal mine safety production are well met. Therefore, the method may provide accurate rockburst early warning information for the coal mining, help a coal mining department take prevention measures in advance, effectively reduce the risk of rockburst occurrence, ensure the coal mine safety production, and improve the production efficiency.

To achieve the above embodiments, the present disclosure also provides a system for rockburst early warning based on multi-scale microstructure parameter fusion of a coal-rock mass. FIG. 3 is a structural diagram of a system for rockburst early warning based on multi-scale microstructure parameter fusion of a coal-rock mass provided by an embodiment of the present disclosure. As shown in FIG. 3, the system includes: a monitoring and analyzing module 100, a determining module 200, a constructing module 300, and an early warning module 400.

The monitoring and analyzing module 100 is configured to collect monitoring data of a coal-rock mass microstructure via a multi-scale microstructure parameter monitoring system including micro-scale monitoring, meso-scale monitoring, and macro-scale monitoring, and obtain a multi-scale microstructure parameter by processing and analyzing the monitoring data, in which the multi-scale microstructure parameter includes a micro-scale structural sensitivity parameter, a meso-scale mechanical response parameter, and a macro-scale energy release parameter.

The determining module 200 is configured to establish a quantitative relationship between the multi-scale microstructure parameter and a risk of rockburst occurrence, and determine a core association mechanism between the multi-scale microstructure parameter and the risk of rockburst occurrence.

The constructing module 300 is configured to construct and train, based on the quantitative relationship and the core association mechanism, a multi-scale microstructure parameter fusion model, in which the fusion model is configured to output a rockburst risk probability based on an input multi-scale fusion parameter.

The early warning module 400 is configured to collect real-time monitoring data of coal-rock mass to be predicted via the multi-scale microstructure parameter monitoring system, and obtain a dynamic rockburst early warning result by inputting the real-time monitoring data into the fusion model trained.

It should be noted that the previous explanation of embodiments of the method for rockburst early warning based on multi-scale microstructure parameter fusion of a coal-rock mass also applies to the system of this embodiment, and an implementation principle is the same, which will not be repeated here.

In summary, the system for rockburst early warning based on multi-scale microstructure parameter fusion of a coal-rock mass according to embodiments of the present disclosure may provide accurate rockburst early warning information for the coal mining, help a coal mining department take prevention measures in advance, effectively reduce the risk of rockburst occurrence, ensure the coal mine safety production, and improve the production efficiency.

To achieve the above embodiments, the present disclosure also provides a non-transitory computer-readable storage medium, which stores a computer program that, when executed by a processor, implements the method for rockburst early warning based on multi-scale microstructure parameter fusion of a coal-rock mass according to any one of embodiments of the first aspect.

The technical solution provided by embodiments of the present disclosure brings at least the following beneficial effects: the present disclosure first constructs a monitoring system that comprehensively covers the multi-scale microstructure of the coal-rock mass, and organically combines micro-scale, meso-scale and macro-scale monitoring technologies. The system may obtain structural change information of the coal-rock mass from different scales and different angles, which breaks a limitation of the traditional single monitoring method and provides a more comprehensive and deeper data support for rockburst prevention. Then, a multi-scale microstructure parameter fusion model is constructed. With the help of a series of dedicated processing and analyzing algorithms for different monitoring data, change features of microstructure parameters related to the rockburst are accurately extracted from massive monitoring data, which realizes an efficient conversion from the data to knowledge, and significantly improves the accuracy and reliability of rockburst prediction. Finally, real-time monitoring and dynamic analysis for the multi-scale microstructure parameter of the coal-rock mass may be achieved in actual application. By constructing a high-speed data collection and transmission system, structural changes of the coal-rock mass during a mining process may be captured in time, and the extracted key parameters are input into the multi-scale microstructure parameter fusion model for the parameter fusion and a rockburst risk assessment. Thus, a strong guarantee is provided for early warning and active prevention of the rockburst, and strict real-time requirements of coal mine safety production are well met. Therefore, the present disclosure may provide accurate rockburst early warning information for the coal mining, help a coal mining department take prevention measures in advance, effectively reduce the risk of rockburst occurrence, ensure the coal mine safety production, and improve the production efficiency.

In the description of the present disclosure, reference throughout this specification to “an embodiment,” “some embodiments,” “example,” “a specific example,” or “some examples,” means that a particular feature, structure, material, or characteristic described in connection with the embodiment or example is included in at least one embodiment or example of the present disclosure. In the specification, the terms mentioned above are not necessarily directed to the same embodiment or example of the present disclosure. Furthermore, the particular features, structures, materials, or characteristics may be combined in any suitable manner in one or more embodiments or examples. In addition, those skilled in the art may combine the different embodiments or examples and the features described thereof in this specification without mutually inconsistent.

In addition, terms such as “first” and “second” are used herein for purposes of description and are not intended to indicate or imply relative importance or significance or to imply the number of indicated technical features. Thus, the feature defined with “first” and “second” may include one or more of this feature. In the description of the present disclosure, “a plurality of” means two or more than two, unless specified otherwise.

Any procedure or method described in the flow charts or described in any other way herein may be understood to include one or more modules, portions or parts for storing executable codes that realize particular logic functions or procedures. Moreover, advantageous embodiments of the present disclosure includes other implementations in which the order of execution is different from that which is depicted or discussed, including executing functions in a substantially simultaneous manner or in an opposite order according to the related functions, which should be understood by those skilled in the art.

The logic and/or steps represented in the flow chart or described in other ways herein, for example, may be regarded as a sequenced list of executable instructions for realizing logical functions, and may be embodied in any computer-readable medium for use by or in combination with an instruction execution system, apparatus or device (such as a computer-based system, a system including a processor or other systems that may read instructions from the instruction execution system, apparatus or device and execute the instructions). For the purposes of this specification, a “computer-readable medium” may be any device that may contain, store, communicate, propagate or transmit a program for use by or in combination with an instruction execution system, apparatus or device. More specific examples (non-exhaustive list) of computer-readable media include: an electrical connection part (electronic device) with one or more wires, a portable computer disk box (magnetic device), a random access memory (RAM), a read-only memory (ROM), an erasable and editable read-only memory (EPROM or flash memory), an optical fiber device, and a portable CD-ROM. In addition, the computer-readable medium may even be paper or other suitable media on which the program may be printed, because the program may be obtained electronically by, for example, optically scanning the paper or other media, followed by editing, interpreting or otherwise processing if necessary, and then stored in the computer memory.

It should be understood that various parts of the present disclosure may be implemented in hardware, software, firmware, or a combination thereof. In the above embodiments, a plurality of steps or methods may be realized by software or firmware stored in a memory and executed by an appropriate instruction execution system. For example, if it is implemented in hardware, as in another embodiment, it may be implemented by any one of the following technologies or their combination: a discrete logic circuit with a logic gate for implementing a logic function on a data signal, an application specific integrated circuit with a suitable combinational logic gate, a programmable gate array (PGA), a field programmable gate array (FPGA), and the like.

Those skilled in the art shall understand that all or parts of the steps in the above exemplifying method of the present disclosure may be achieved by commanding the related hardware with programs. The programs may be stored in a computer readable storage medium, and the programs include one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks or CD, etc. Although embodiments of the present disclosure have been shown and described, it would be appreciated by those skilled in the art that the above embodiments are illustrative and cannot be construed to limit the present disclosure, and changes, modifications, alternatives and varieties may be made in the embodiments by those skilled in the art within the scope of the present disclosure.

What is claimed is:

1. A method for rockburst early warning based on multi-scale microstructure parameter fusion of a coal-rock mass, comprising:
collecting monitoring data of a coal-rock mass microstructure via a monitoring system comprising micro-scale monitoring, meso-scale monitoring, and macro-scale monitoring, and obtaining a multi-scale microstructure parameter by processing the monitoring data, wherein the multi-scale microstructure parameter comprises a micro-scale structural sensitivity parameter, a meso-scale mechanical response parameter, and a macro-scale energy release parameter;
establishing a quantitative relationship between the multi-scale microstructure parameter and a risk of rockburst occurrence, and determining a core association mechanism between the multi-scale microstructure parameter and the risk of rockburst occurrence;
constructing and training a fusion model based on the quantitative relationship and the core association mechanism, wherein the fusion model is configured to output a rockburst risk probability based on an input multi-scale fusion parameter; and
collecting real-time monitoring data of a coal-rock mass to be predicted via the monitoring system, and obtaining a dynamic rockburst early warning result by inputting the real-time monitoring data into the fusion model trained.

2. The method according to claim 1, wherein establishing the quantitative relationship between the multi-scale microstructure parameter and the risk of rockburst occurrence comprises:
establishing a non-linear mapping relationship between the risk of rockburst occurrence and the multi-scale microstructure parameter based on historical rockburst instances;
determining, based on the non-linear mapping relationship, a relationship between a risk early warning triggering rule and a related microstructure parameter, and a relationship between a risk probability escalation rule and the related microstructure parameter; and
quantifying a contribution degree of each microstructure parameter to the risk of rockburst occurrence by using a Shapley value analysis method.

3. The method according to claim 1, wherein determining the core association mechanism between the multi-scale microstructure parameter and the risk of rockburst occurrence comprises:
determining, based on a mechanical association analysis result, an association mechanism between micro-scale structural deterioration of the coal-rock mass and a stress concentration effect;
determining, by analyzing the meso-scale mechanical response parameter, an association mechanism between meso-scale damage evolution of the coal-rock mass and energy transfer abnormality; and
determining, by analyzing the macro-scale energy release parameter, an association mechanism between macro-scale energy release and an instability critical point of the coal-rock mass.

4. The method according to claim 1, wherein before constructing the fusion model, the method further comprises:
performing normalization processing on the multi-scale microstructure parameter;
calculating, by using a mutual information (MI) method, a correlation degree between each normalized microstructure parameter and a rockburst event, and calculating a Spearman correlation coefficient corresponding to each microstructure parameter based on the correlation degree; and
screening out a plurality of key parameters from the multi-scale microstructure parameter by using a recursive feature elimination (RFE) algorithm based on the Spearman correlation coefficient of each microstructure parameter, wherein a Spearman correlation coefficient of each of the key parameters is greater than a preset screening threshold.

5. The method according to claim 4, wherein the multi-scale microstructure parameter fusion model comprises: a feature extraction layer, a cross-scale fusion layer, and a risk assessment layer,
wherein the feature extraction layer is a bottom layer, configured to extract, from an input multi-scale microstructure parameter, a data feature corresponding to the key parameter; for microscopic image data, a convolutional neural network (CNN) is configured to extract the data feature; and for time-series data, a long short-term memory (LSTM) network is configured to extract the data feature;
the cross-scale fusion layer is a middle layer, configured to map different data features to a unified feature space and calculate a contribution weight of each of the data features to rockburst; and
the risk assessment layer is a top layer, configured to output the rockburst risk probability.

6. The method according to claim 1, wherein the micro-scale structural sensitivity parameter comprises: a plurality of micro-pore parameters, a plurality of micro-crack parameters, and a plurality of mineral structure parameters, and obtaining the multi-scale microstructure parameter by processing and analyzing the monitoring data comprises:
performing binarization processing on microscopic image data collected by using a microscopic imaging technology, and calculating the plurality of micro-pore parameters based on a binarization processing result;
extracting a crack centerline from the microscopic image data, identifying a crack initiation position and a crack propagation trajectory from an in-situ computed tomography (CT) image sequence, and calculating the plurality of micro-crack parameters based on obtained crack information; and
calculating the plurality of mineral structure parameters by identifying a mineral phase and analyzing a grain boundary change based on the in-situ CT image sequence.

7. The method according to claim 1, wherein the meso-scale mechanical response parameter comprises: an ultrasonic attenuation coefficient and a meso-scale strain localization degree, and obtaining the multi-scale microstructure parameter further comprises:
calculating the ultrasonic attenuation coefficient by processing a collected ultrasonic computed tomography (CT) signal; and
calculating the meso-scale strain localization degree by analyzing a coal-rock mass deformation image, wherein the coal-rock mass deformation image is collected by using a digital image correlation (DIC) technology.

8. The method according to claim 1, wherein the macro-scale energy release parameter comprises: a cumulative value of micro-seismic energy and a high-frequency component proportion of an acoustic emission signal, and obtaining the multi-scale microstructure parameter further comprises:
calculating the cumulative value of micro-seismic energy by analyzing a micro-seismic event parameter collected by a micro-seismic monitoring system; and
calculating the high-frequency component proportion of the acoustic emission signal by analyzing an acoustic emission signal inside the coal-rock mass, wherein the acoustic emission signal inside the coal-rock mass is collected by using an acoustic emission monitoring technology.

9. A system for rockburst early warning based on multi-scale microstructure parameter fusion of a coal-rock mass, comprising:
a monitoring system comprising micro-scale monitoring, meso-scale monitoring, and macro-scale monitoring, configured to collect monitoring data of a coal-rock mass microstructure, and collect real-time monitoring data of a coal-rock mass to be predicted;
a computer device comprising a memory and a processor, wherein when instructions in the memory are executed, the processor is configured to
obtain a multi-scale microstructure parameter by processing the monitoring data, wherein the multi-scale microstructure parameter comprises a micro-scale structural sensitivity parameter, a meso-scale mechanical response parameter, and a macro-scale energy release parameter;
establish a quantitative relationship between the multi-scale microstructure parameter and a risk of rockburst occurrence, and determine a core association mechanism between the multi-scale microstructure parameter and the risk of rockburst occurrence;
construct and train a fusion model based on the quantitative relationship and the core association mechanism, wherein the fusion model is configured to output a rockburst risk probability based on an input multi-scale fusion parameter; and
obtain a dynamic rockburst early warning result by inputting the real-time monitoring data into the fusion model trained.

10. The system according to claim 9, wherein the processor is further configured to:
establish a non-linear mapping relationship between the risk of rockburst occurrence and the multi-scale microstructure parameter based on historical rockburst instances;
determine, based on the non-linear mapping relationship, a relationship between a risk early warning triggering rule and a related microstructure parameter, and a relationship between a risk probability escalation rule and the related microstructure parameter; and
quantify a contribution degree of each microstructure parameter to the risk of rockburst occurrence by using a Shapley value analysis method.

11. The system according to claim 9, wherein the processor is further configured to:
determine, based on a mechanical association analysis result, an association mechanism between micro-scale structural deterioration of the coal-rock mass and a stress concentration effect;
determine, by analyzing the meso-scale mechanical response parameter, an association mechanism between meso-scale damage evolution of the coal-rock mass and energy transfer abnormality; and
determine, by analyzing the macro-scale energy release parameter, an association mechanism between macro-scale energy release and an instability critical point of the coal-rock mass.

12. The system according to claim 9, wherein before constructing the fusion model, the processor is further configured to:
perform normalization processing on the multi-scale microstructure parameter;
calculate, by using a mutual information (MI) method, a correlation degree between each normalized microstructure parameter and a rockburst event, and calculate a Spearman correlation coefficient corresponding to each microstructure parameter based on the correlation degree; and
screen out a plurality of key parameters from the multi-scale microstructure parameter by using a recursive feature elimination (RFE) algorithm based on the Spearman correlation coefficient of each microstructure parameter, wherein a Spearman correlation coefficient of each of the key parameters is greater than a preset screening threshold.

13. The system according to claim 12, wherein the multi-scale microstructure parameter fusion model comprises: a feature extraction layer, a cross-scale fusion layer, and a risk assessment layer,
wherein the feature extraction layer is a bottom layer, configured to extract, from an input multi-scale microstructure parameter, a data feature corresponding to the key parameter; for microscopic image data, a convolutional neural network (CNN) is configured to extract the data feature; and for time-series data, a long short-term memory (LSTM) network is configured to extract the data feature;
the cross-scale fusion layer is a middle layer, configured to map different data features to a unified feature space and calculate a contribution weight of each of the data features to rockburst; and
the risk assessment layer is a top layer, configured to output the rockburst risk probability.

14. The system according to claim 9, wherein the micro-scale structural sensitivity parameter comprises: a plurality of micro-pore parameters, a plurality of micro-crack parameters, and a plurality of mineral structure parameters, and the processor is further configured to:
perform binarization processing on microscopic image data collected by using a microscopic imaging technology, and calculate the plurality of micro-pore parameters based on a binarization processing result;
extract a crack centerline from the microscopic image data, identify a crack initiation position and a crack propagation trajectory from an in-situ computed tomography (CT) image sequence, and calculate the plurality of micro-crack parameters based on obtained crack information; and
calculate the plurality of mineral structure parameters by identifying a mineral phase and analyzing a grain boundary change based on the in-situ CT image sequence.

15. The system according to claim 9, wherein the meso-scale mechanical response parameter comprises: an ultrasonic attenuation coefficient and a meso-scale strain localization degree, and the processor is further configured to:
calculate the ultrasonic attenuation coefficient by processing a collected ultrasonic computed tomography (CT) signal; and
calculate the meso-scale strain localization degree by analyzing a coal-rock mass deformation image, wherein the coal-rock mass deformation image is collected by using a digital image correlation (DIC) technology.

16. The system according to claim 9, wherein the macro-scale energy release parameter comprises: a cumulative value of micro-seismic energy and a high-frequency component proportion of an acoustic emission signal, and the processor is further configured to:
calculate the cumulative value of micro-seismic energy by analyzing a micro-seismic event parameter collected by a micro-seismic monitoring system; and
calculate the high-frequency component proportion of the acoustic emission signal by analyzing an acoustic emission signal inside the coal-rock mass, wherein the acoustic emission signal inside the coal-rock mass is collected by using an acoustic emission monitoring technology.

17. A non-transitory computer-readable storage medium, storing a computer program that, when executed by a processor, implements a method for rockburst early warning based on multi-scale microstructure parameter fusion of a coal-rock mass, the method comprising:
collecting monitoring data of a coal-rock mass microstructure via a monitoring system comprising micro-scale monitoring, meso-scale monitoring, and macro-scale monitoring, and obtaining a multi-scale microstructure parameter by processing the monitoring data, wherein the multi-scale microstructure parameter comprises a micro-scale structural sensitivity parameter, a meso-scale mechanical response parameter, and a macro-scale energy release parameter;
establishing a quantitative relationship between the multi-scale microstructure parameter and a risk of rockburst occurrence, and determining a core association mechanism between the multi-scale microstructure parameter and the risk of rockburst occurrence;
constructing and training a fusion model based on the quantitative relationship and the core association mechanism, wherein the fusion model is configured to output a rockburst risk probability based on an input multi-scale fusion parameter; and
collecting real-time monitoring data of a coal-rock mass to be predicted via the monitoring system, and obtaining a dynamic rockburst early warning result by inputting the real-time monitoring data into the fusion model trained.
